(19) United States
(12) Patent Application Publication
(10) Pub. No.: US 2026/0233114 A1
(43) Pub. Date: Aug. 13, 2026

(54) AUTOMATED MOVING BODY AND MOVEMENT CONTROL METHOD

(71) Applicant: SONY GROUP CORPORATION, TOKYO (JP)

(72) Inventors: KENSUKE KITAMURA, TOKYO (JP); KATSUHISA ITO, TOKYO (JP)

(21) Appl. No.: 19/151,460

(22) PCT Filed: Jan. 22, 2024
(86) PCT No.: PCT/JP2024/001558

§ 371 Date: Jul. 28, 2025

(30) Foreign Application Priority Data
Feb. 8, 2023 (JP) 2023-017594

(51) Int. Cl. A63H 11/20

(52) U.S. Cl. CPC A63H 11/20

(57) ABSTRACT

The present technology relates to an automated moving body and a movement control method enabling suppression of footstep sound of the automated moving body. The automated moving body includes two or more legs and a motion control unit that controls each of the legs such that a force of a free leg out of the legs is released before ground contact of the free leg and the force of the leg is applied after the ground contact of the free leg. The present technology is applicable to, for example, a robot of a pet type.

### TECHNICAL FIELD

The present technology relates to an automated moving body and a movement control method, and particularly relates to an automated moving body and a movement control method capable of suppressing footstep sound.

### BACKGROUND ART

In a quadruped robot, there is a case in which the body is inclined due to hardware factors such as insufficient rigidity of the body and backlash and consequently the legs do not move along target trajectories. In this case, the leg collides with the ground at a certain speed at the time of walk, and ground contact sound (footstep sound), for example, clicking sound sometimes occurs.

Moreover, in the past, it has been proposed to achieve walk high in energy efficiency through use of a walk pattern of a walking robot to adjust rigidity of leg portions (for example, see PTL 1).

### CITATION LIST

### Patent Literature

### [PTL 1]

Japanese Patent Laid-open No. 2008-12657

### SUMMARY

### Technical Problem

However, in PTL 1, how the rigidity of the leg portion is adjusted is not specifically described. Moreover, in PTL 1, the suppression of the footstep sound of the walking robot is not considered.

The present technology has been made in view of such a situation and enables suppression of footstep sound of an automated moving body such as a quadruped robot.

### Solution to Problem

An automated moving body in one aspect of the present technology includes two or more legs and a motion control unit that controls each of the legs such that a force of a free leg out of the legs is released before ground contact of the free leg and the force of the free leg is applied after the ground contact of the free leg.

A movement control method in one aspect of the present technology includes, by an automated moving body including two or more legs, controlling a motion of each of the legs such that a force of a free leg out of the legs is released before ground contact of the free leg and the force of the free leg is applied after the ground contact of the free leg.

In one aspect of the present technology, the force of the free leg out of the two or more legs is released before the ground contact of the free leg and the force of the free leg is applied after the ground contact of the free leg.

### BRIEF DESCRIPTION OF DRAWINGS

FIG. 1 is a perspective view for an automated moving body to which the present technology is applied.

FIG. 2 is a diagram for illustrating a configuration example of actuators of the automated moving body.

FIG. 3 is a block diagram for illustrating a configuration example of functions of a movement control system of the automated moving body.

FIG. 4 is a flowchart for describing movement control processing executed by the automated moving body.

FIG. 5 is a timing chart for describing an estimation method for a ground contact timing of the automated moving body, and the like.

FIG. 6 is a block diagram for illustrating a configuration example of a computer.

### DESCRIPTION OF EMBODIMENT

A description is now given of an embodiment of the present technology. The description is given in the following sequence.
1. Embodiment
2. Modification Examples
3. Others

### 1. EMBODIMENT

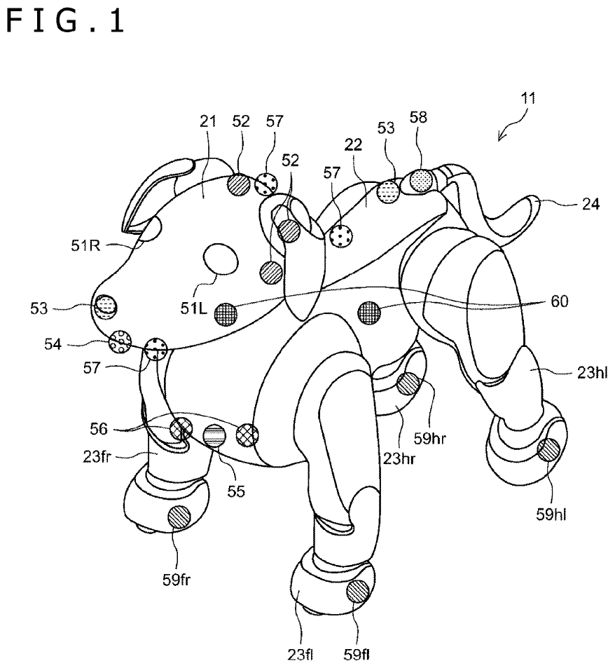

A description is now given of the embodiment according to the present technology with reference to FIG. 1 to FIG. 5.

### Hardware Configuration Example of Automated Moving Body 11

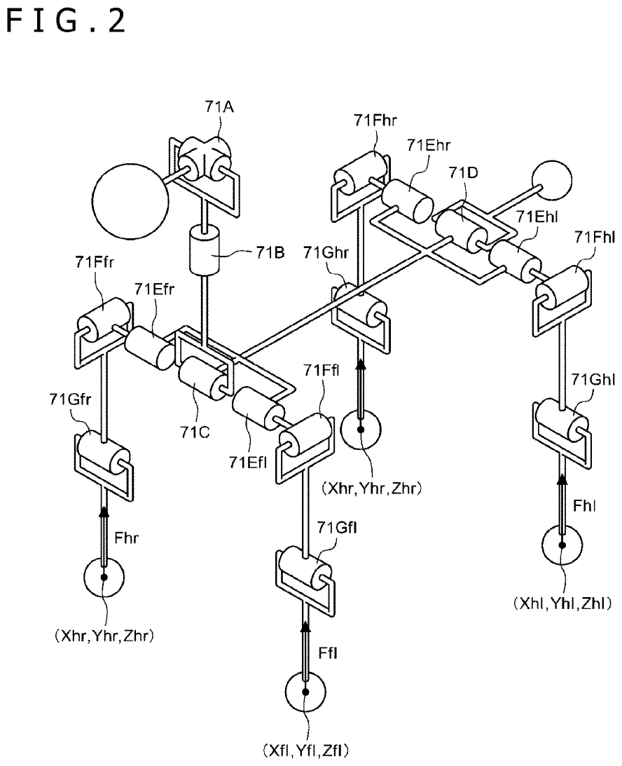

First, with reference to FIG. 1 and FIG. 2, a description is given of a hardware configuration example of an automated moving body 11.

FIG. 1 is a perspective view of the automated moving body 11. Moreover, FIG. 1 illustrates a configuration example of displays and sensors of the automated moving body 11.

The automated moving body 11 is a dog-type quadruped walking robot including a head portion 21, a body portion 22, four leg portions 23fl to a leg portion 23hr, and a tail portion 24. Note that, in a case in which it is not required to individually distinguish the leg portion 23fl to the leg portion 23hr from one another, they are hereinafter simply referred to as leg portions 23.

The automated moving body 11 includes two displays 51L and 51R in the head portion 21. Note that, in a case in which it is not required to individually distinguish the display 51L and the display 51R from each other, they are hereinafter simply referred to as displays 51.

Each display 51 has a function of visually expressing motions of the eyes and sentiment of the automated moving body 11. For example, each display 51 expresses motions of the eyeball, the pupil, and the eyelid according to the sentiment and the motion to produce natural motions similar to an existing animal such as a dog, and this can highly accurately and flexibly express the lines of sight and the sentiment of the automated moving body 11. Moreover, a user can intuitively recognize the state of the automated moving body 11 from the motions of the eyes displayed on the displays 51.

Moreover, the automated moving body 11 includes various sensors. For example, the automated moving body 11 includes microphones 52, cameras 53, a ToF (Time Of Flight) sensor 54, a human sensor 55, ranging sensors 56, touch sensors 57, an illuminance sensor 58, leg tip sensors 59fl to 59hr, and IMUs (Inertial Measurement Units) 60. Note that, in a case in which it is not required to individually distinguish the leg tip sensors 59fl to 59hr from one another, they are hereinafter generally referred to as leg tip sensors 59.

The automated moving body 11 includes, for example, four microphones 52 in the head portion 21. Each microphone 52 collects sound in the periphery including, for example, a conversation of the user and peripheral environmental sound. Moreover, the provision of the plurality of microphones 52 enables highly sensitive collection of the sound generated in the periphery and localization of a sound source.

The automated moving body 11 includes, for example, the two wide-angle cameras 53 at a tip of the nose and in the waist portion to capture an image of the periphery of the automated moving body 11. For example, the camera 53 disposed at the tip of the nose executes capturing an image in a forward field of view of the automated moving body 11 (that is, the field of view of the dog). The camera 53 disposed in the waist portion executes capturing an image of a periphery centered around a portion above the automated moving body 11. The automated moving body 11, for example, extracts a feature point of a ceiling and the like on the basis of an image captured by the camera 53 disposed in the waist portion, so that the SLAM (Simultaneous Localization and Mapping) can be achieved.

The ToF sensor 54 is provided to, for example, the tip of the nose and detects the distance to an object existing forward of the head portion 21. The automated moving body 11 uses the ToF sensor 54 to be able to highly accurately detect the distances to various objects, and this can achieve a motion according to relative positions of target objects including the user and obstacles.

The human sensor 55 is disposed in, for example, the chest portion and detects locations of the user and a pet kept by the user. The automated moving body 11 detects a moving object existing forward of the human sensor 55, and can express various motions for this moving object, for example, motions corresponding to sentiment such as interest, fear, and surprise.

The ranging sensors 56 are disposed in, for example, the chest portion, and detect a situation of a floor surface forward of the automated moving body 11. The automated moving body 11 can use the ranging sensors 56 to highly accurately detect the distance to an object existing on the forward floor surface and can achieve a motion corresponding to the relative position to this object.

The touch sensors 57 are disposed in portions, for example, a top of the head, the lower jaw, and the back at which the user highly possibly touches the automated moving body 11 and detects the contact (touch) of the user. The touch sensor 57 includes, for example, a touch sensor of the capacitive type or the pressure sensitive type. The automated moving body 11 can use the touch sensors 57 to detect a contact behavior of the user such as touching, stroking, hitting, and pushing and can conduct a motion according to this contact behavior. Moreover, for example, the touch sensor 57 is disposed in each portion in a line form or a surface form, resulting in enabling detection of a touched position in each portion.

The illuminance sensor 58 is disposed, for example, at a base of the tail portion 24 on a rear surface of the head portion 21 and detects the illuminance of a space in which the automated moving body 11 is placed. The automated moving body 11 uses the illuminance sensor 58 to detect the illuminance of the periphery, and can execute a motion according to this illuminance.

Each leg tip sensor 59 is disposed in a portion corresponding to the pad of the leg tip (foot sole) of each leg portion 23. Each leg tip sensor 59 includes, a load sensor or a force sensor and detects a load applied to each leg portion 23.

The IMUs 60 are disposed in, for example, predetermined portions (for example, the head portion 21 and the body portion 22), respectively, and detect physical quantities such as the speed, the acceleration, and the rotation of the respective portions. For example, the IMU 60 includes a 6-axis sensor which detects the accelerations and the angular velocities on the X axis, the Y axis, and the Z axis. The automated moving body 11 uses the IMUs 60 to highly accurately detect the motions of the head portion 21 and the body portion 22, and can achieve motion control according to a situation.

Note that the configuration of the sensors of the automated moving body 11 may flexibly be changed according to specifications, the operation, and the like. For example, the automated moving body 11 may further include, in addition to the configuration described above, for example, a temperature sensor, various communication apparatuses including a GNSS (Global Navigation Satellite System) signal receiver.

FIG. 2 illustrates a configuration example of joint portions of the automated moving body 11. More specifically, FIG. 2 illustrates a configuration example of actuators driving the joint portions of the automated moving body 11.

The automated moving body 11 includes an actuator 71A, an actuator 71B, an actuator 71C, an actuator 71D, actuators 71Efl to 71Ehr, actuators 71Ffl to 71Fhr, and actuators 71Gfl to 71Ghr.

Note that, in a case in which it is not required to individually distinguish the actuators 71Efl to 71Ehr from one another, they are hereinafter simply referred to as actuators 71E. In a case in which it is not required to individually distinguish the actuators 71Ffl to 71Fhr from one another, they are hereinafter simply referred to as actuators 71F. In a case in which it is not required to individually distinguish the actuators 71Gfl to 71Ghr from one another, they are hereinafter simply referred to as actuators 71G. In a case in which it is not required to individually distinguish the actuators 71A to 71G from one another, they are hereinafter simply referred to as actuators 71.

Each actuator 71 includes a servo motor, for example.

The actuator 71A is a two-axis actuator and controls a motion (rotation) of the head portion 21 about the roll axis and the pitch axis.

The actuator 71B is a one-axis actuator and controls a motion (rotation) of the head portion 21 about the yaw axis.

The actuator 71C is a one-axis actuator and controls a motion (rotation) of a neck portion about the pitch axis.

The actuator 71D is a one-axis actuator and controls a motion (rotation) of the tail portion 24 about the pitch axis.

The actuator 71Efl is a one-axis actuator and controls a motion (rotation) of a shoulder joint of the leg portion 23fl about the pitch axis. The actuator 71Efl is a one-axis actuator and controls a motion (rotation) of the shoulder joint of the leg portion 23fl about the roll axis. The actuator 71Gfl is a one-axis actuator and controls a motion (rotation) of an elbow joint of the leg portion 23fl about the pitch axis.

The actuator 71Efr is a one-axis actuator and controls a motion (rotation) of the shoulder joint of the leg portion 23fr about the pitch axis. The actuator 71Ffr is a one-axis actuator and controls a motion (rotation) of the shoulder joint of the leg portion 23fr about the roll axis. The actuator 71Gfr is a one-axis actuator and controls a motion (rotation) of the elbow joint of the leg portion 23fr about the pitch axis.

The actuator 71Ehl is a one-axis actuator and controls a motion (rotation) of a hip joint of the leg portion 23hl about the pitch axis. The actuator 71Fhl is a one-axis actuator and controls a motion (rotation) of the hip joint of the leg portion 23hl about the roll axis. The actuator 71Ghl is a one-axis actuator and controls a motion (rotation) of a knee joint of the leg portion 23hl about the pitch axis.

The actuator 71Ehr is a one-axis actuator and controls a motion (rotation) of the hip joint of the leg portion 23hr about the pitch axis. The actuator 71Fhr is a one-axis actuator and controls a motion (rotation) of the hip joint of the leg portion 23hr about the roll axis. The actuator 71Ghr is a one-axis actuator and controls a motion (rotation) of the knee joint of the leg portion 23hr about the pitch axis.

### Configuration Example of Movement Control System

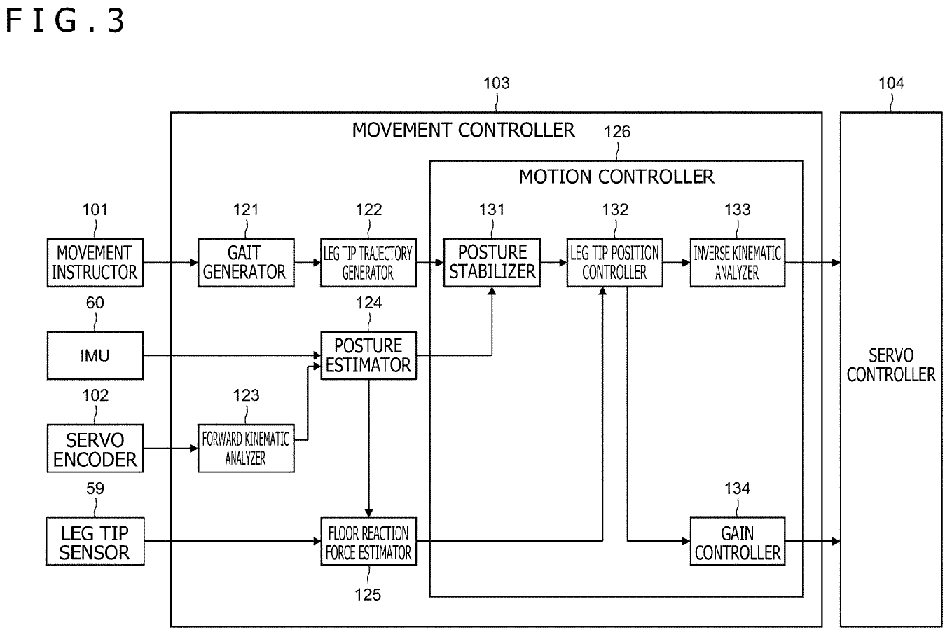

FIG. 3 illustrates a configuration example of the movement control system which controls the movement of the automated moving body 11 through use of the leg portions 23.

The movement of the automated moving body 11 through use of the leg portions 23 includes walk and run of the automated moving body 11. Note that the walk and the run of the automated moving body 11 are not different from each other in strict definition and are distinguished from each other on the basis of, for example, the movement speed and the motions of the leg portions 23.

A movement control system of the automated moving body 11 includes the leg tip sensors 59, the IMUs 60, a movement instructor 101, servo encoders 102, a movement controller 103, and a servo controller 104.

The movement controller 103 controls the movement of the automated moving body 11. The movement controller 103 includes a gait generator 121, a leg tip trajectory generator 122, a forward kinematic analyzer 123, a posture estimator 124, a floor reaction force estimator 125, and a motion controller 126.

The motion controller 126 controls the motion of each leg portion 23. The motion controller 126 includes a posture stabilizer 131, a leg position controller 132, an inverse kinematic analyzer 133, and a gain controller 134.

The leg tip sensor 59, as described before, is provided to the leg tip of each leg portion 23 and detects the load applied to the leg tip of each leg portion 23. Each leg tip sensor 59 generates a signal (hereinafter referred to as a leg tip load detection signal) indicating a detection result of the load applied to the leg tip of each leg portion 23 and supplies the leg tip load detection signal to the floor reaction force estimator 125.

Each of the IMUs 60 is provided to each of the predetermined portions (for example, each of the head portion 21 and the body portion 22) and detects the accelerations and angular velocities of each portion. Each IMU 60 generates a signal (hereinafter referred to as inertia measurement signal) indicating a detection result of the accelerations, the angular velocities, and the like of each portion and supplies the inertia measurement signal to the posture estimator 124.

The movement instructor 101 plans the movement of the automated moving body 11 on the basis of, for example, the automated moving body 11 and a peripheral situation. The movement instructor 101 generates a movement command which instructs the planned movement of the automated moving body 11 and supplies the movement command to the gait generator 121.

The servo encoder 102 is provided to, for example, each actuator 71. Each servo encoder 102 detects the angle in the rotation direction of each actuator 71 to detect a rotation angle (hereinafter referred to as a joint angle) of each joint of the automated moving body 11. Each servo encoder 102 generates a signal (hereinafter referred to as a joint angle detection signal) indicating a detection result of the joint angle of each joint and supplies the joint angle detection signal to the forward kinematic analyzer 123.

The gait generator 121 plans a gait of the automated moving body 11, that is, a way of moving each leg portion 23 of the automated moving body 11 at the movement time on the basis of the movement command. The gait generator 121 generates information (hereinafter referred to as gait information) indicating the planned gait. The gait generator 121 supplies the movement command and the gait information to the leg tip trajectory generator 122.

The leg tip trajectory generator 122 plans the trajectory of the leg tip of each leg portion 23 on the basis of the movement command and the gait information. The leg tip trajectory generator 122 generates information (hereinafter referred to as leg tip trajectory plan information) indicating the planned trajectory of the leg tips, and supplies the leg tip trajectory plan information to the posture stabilizer 131.

The forward kinematic analyzer 123 detects the position and posture of the leg tip of each leg portion 23 on the basis of the joint angle detection signal from each servo encoder 102. The forward kinematic analyzer 123 generates information (hereinafter referred to as leg tip position detection information) indicating a detection result of the position and posture of the leg tip of each leg portion 23 and supplies the leg tip position detection information to the posture estimator 124.

The posture estimator 124 estimates the posture of the automated moving body 11 on the basis of the inertia measurement signal from each IMU 60 and the leg tip position detection information from the forward kinematic analyzer 123. The posture estimator 124 generates information (hereinafter referred to as posture estimation information) indicating an estimation result of the posture of the automated moving body 11 and supplies the posture estimation information to the floor reaction force estimator 125 and the posture stabilizer 131.

The floor reaction force estimator 125 estimates a floor reaction force applied to each leg portion 23 on the basis of the posture estimation information and the leg tip load detection signal from each leg tip sensor 59. The floor reaction force estimator 125 generates information (hereinafter referred to as floor reaction force estimation information) indicating an estimation result of the floor reaction force applied to each leg portion 23 and supplies the floor reaction force estimation information to the leg tip position controller 132.

Moreover, the floor reaction force estimator 125 estimates a timing of the ground contact of each leg portion 23 on the basis of the leg tip load detection signal from each leg tip sensor 59. The floor reaction force estimator 125 generates information (hereinafter referred to as ground contact timing estimation information) indicating an estimation result of the ground contact timing of each leg portion 23 and supplies the ground contact timing estimation information to the leg tip position controller 132.

The posture stabilizer 131 calculates the position of the center of gravity which stabilizes the posture of the automated moving body 11, and the like on the basis of the posture estimation information. The posture stabilizer 131 generates information (hereinafter referred to as posture stabilization information) indicating the calculated position of the center of gravity, and the like. The posture stabilizer 131 supplies the leg tip trajectory plan information and the posture stabilization information to the leg tip position controller 132.

The leg tip position controller 132 corrects the trajectory of the leg tip of each leg portion 23 on the basis of the leg tip trajectory plan information and the posture stabilization information. The leg tip position controller 132 generates information (hereinafter referred to as leg tip trajectory corrected information) indicating the trajectory of the leg tip of each leg portion 23 after the correction and supplies the leg tip trajectory corrected information to the inverse kinematic analyzer 133.

Moreover, the leg tip position controller 132 corrects an estimation result of the ground contact timing of each leg tip on the basis of the ground contact timing estimation information and the trajectory of the leg tip of each leg portion 23 after the correction. The leg tip position controller 132 determines whether or not a leg tip phase (the phase of a movement cycle of the leg tip of each leg portion 23) of each leg portion 23 is in a ground contact phase (in a vicinity of the timing of the ground contact) on the basis of the estimated ground contact timing of each leg portion 23 after the correction. The leg tip position controller 132 generates information (hereinafter referred to as ground contact determination information) indicating a determination result of whether or not each leg portion 23 is in the ground contact phase and supplies the ground contact determination information to the gain controller 134.

The inverse kinematic analyzer 133 calculates target values of the joint angles of each leg portion 23 on the basis of the leg tip trajectory corrected information. The inverse kinematic analyzer 133 generates information (hereinafter referred to as joint angle plan information) indicating target values of the joint angles of each leg portion 23 and supplies the joint angle plan information to the servo controller 104.

The gain controller 134 controls each actuator 71 for driving the joint of each leg portion 23 on the basis of the ground contact determination information. The gain controller 134 generates information (hereinafter referred to as gain information) indicating the servo gain of each actuator 71 and supplies the gain information to the servo controller 104.

The servo controller 104 sets the servo gain of each actuator 71 for driving the joint of each leg portion 23 on the basis of the gain information. Moreover, the servo controller 104 controls each actuator 71 for driving the joint of each leg portion 23 on the basis of the joint angle plan information and controls the joint angles of each leg portion 23.

### <Movement Control Processing>

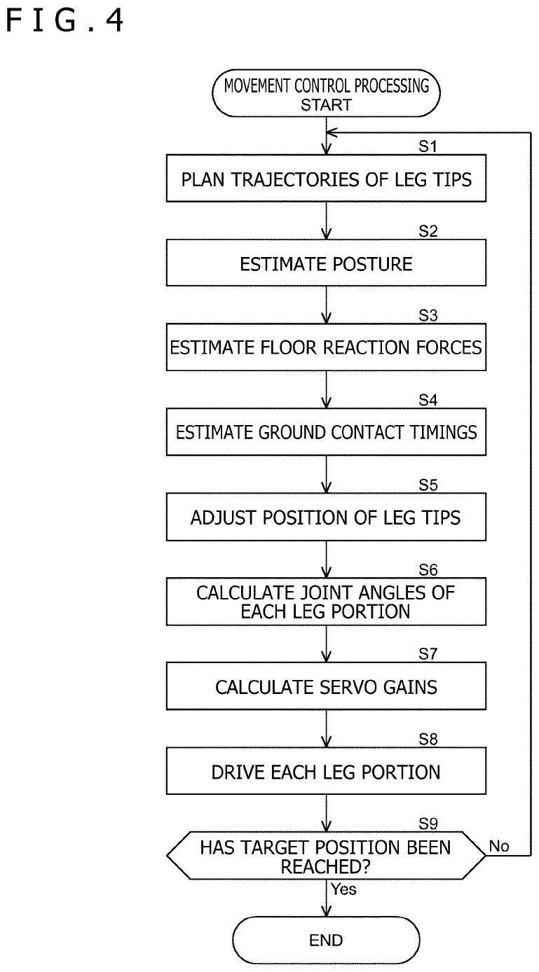

With reference to a flowchart of FIG. 4, a description is now given of movement control processing executed by the automated moving body 11.

In Step S1, the automated moving body 11 plans the trajectories of the leg tips.

Specifically, the movement instructor 101 plans the movement of the automated moving body 11 on the basis of the automated moving body 11, the peripheral situation, and the like. The movement instructor 101 generates the movement command which instructs the planned movement of the automated moving body 11 and supplies the movement command to the gait generator 121. The instruction command includes, for example, a travel distance, a travel speed, a turn angle, and the gait of the automated moving body 11.

The gait generator 121 plans the gait of the automated moving body 11 on the basis of the movement command. The gait generator 121 generates the gait information indicating the planned gait. The gait generator 121 supplies the movement command and the gait information to the leg tip trajectory generator 122.

The leg tip trajectory generator 122 plans the trajectory of the leg tip of each leg portion 23 on the basis of the movement command and the gait information. The leg tip trajectory generator 122 generates leg tip trajectory plan information indicating the planned trajectories of the leg tips and supplies the leg tip trajectory plan information to the posture stabilizer 131.

Note that a target position P1fl of the leg tip of the leg portion 23fl, a target position P1fr of the leg tip of the leg portion 23fr, a target position P1hl of the leg tip of the leg portion 23hl, and a target position P1hr of the leg tip of the leg portion 23hr based on the leg tip trajectory plan information are hereinafter defined as given by the following Expressions (1) to (4).

$$P 1 fl = ( Xfl , Yfl , Zfl ) \qquad ( 1 )$$

$$P 1 fr = ( Xfr , Yfr , Zfr ) \qquad ( 2 )$$

$$P 1 hl = ( Xhl , Yhl , Zhl ) \qquad ( 3 )$$

$$P 1 hr = ( Xhr , Yhr , Zhr ) \qquad ( 4 )$$

That is, the target position of the leg tip of each leg portion 23 is represented in coordinates on the X axis, the Y axis, and the Z axis.

In Step S2, the automated moving body 11 estimates the posture.

Specifically, each of the IMUs 60 detects the acceleration and angular velocity of the predetermined portion (for example, the head portion 21 or the body portion 22). Each IMU 60 generates the inertia measurement signal indicating the detection result of the acceleration and angular velocity of each portion and supplies the inertia measurement signal to the posture estimator 124.

Each servo encoder 102 detects the joint angle of each joint of the automated moving body 11 on the basis of the rotation angle of each actuator 71. Each servo encoder 102 generates the joint angle detection signal indicating the detection result of each joint angle and supplies the joint angle detection signal to the forward kinematic analyzer 123.

The forward kinematic analyzer 123 detects the position and posture of the leg tip of each leg portion 23 on the basis of the joint angle of each joint of the automated moving body 11. The forward kinematic analyzer 123 generates the leg tip position detection information indicating the detection result of the position and posture of the leg tip of each leg portion 23 and supplies the leg tip position detection information to the posture estimator 124.

The posture estimator 124 estimates the posture of the automated moving body 11 on the basis of the accelerations and angular velocities of the predetermined positions of the automated moving body 11 and the position and posture of the leg tip of each leg portion 23. For example, the posture estimator 124 estimates, for example, the Zero Moment Point (ZMP) of the automated moving body 11. The posture estimator 124 generates the posture estimation information indicating the estimated posture of the automated moving body 11 and supplies the posture estimation information to the floor reaction force estimator 125 and the posture stabilizer 131.

In Step S3, the automated moving body 11 estimates the floor reaction forces.

Specifically, each leg tip sensor 59 detects the load applied to the leg tip of each leg portion 23. Each leg tip sensor 59 generates a leg tip load signal indicating a detection result of the load applied to the leg tip of each leg portion 23 and supplies the leg tip load signal to the floor reaction force estimator 125.

The floor reaction force estimator 125 estimates the floor reaction force applied to each leg portion 23 on the basis of the load applied to the leg tip of each leg portion 23 and the estimated posture of the automated moving body 11. The floor reaction force estimator 125 generates the floor reaction force estimation information indicating the estimation result of the floor reaction force applied to each leg portion 23 and supplies the floor reaction force estimation information to the leg tip position controller 132.

Note that the floor reaction force applied to the leg portion 23fl is hereinafter denoted as Ffl. The floor reaction force applied to the leg portion 23fr is hereinafter denoted as Ffr. The floor reaction force applied to the leg portion 23hl is hereinafter denoted as Fhl. The floor reaction force applied to the leg portion 23hr is hereinafter denoted as Fhr.

In Step S4, the floor reaction force estimator 125 estimates the ground contact timings.

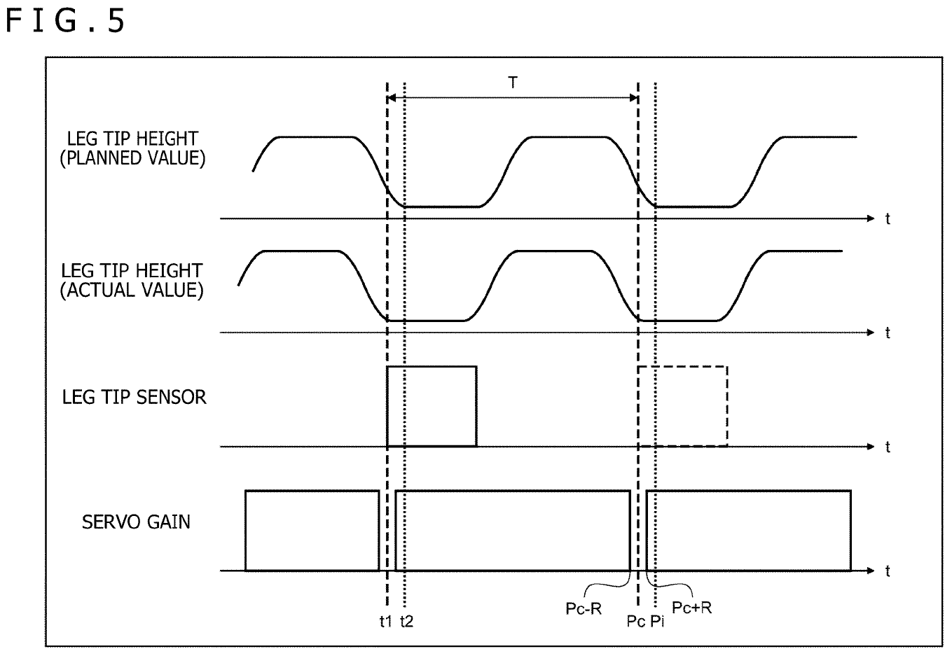

With reference to FIG. 5, a description is now given of an example of an estimation method for the ground contact timing.

FIG. 5 indicates, as time series, transitions of a planned value of the height of the leg tip, an actual value of the height of the leg tip, the detection value of the leg tip sensor 59, and the servo gain of one of the leg portions 23 of the automated moving body 11.

Note that, in this example, for the sake of easy-to-understand description, there is described an example in which a foot sole switch is used as the leg tip sensor 59 in place of a load sensor or a force sensor. That is, an output value of the leg tip sensor 59 becomes a High level in a case in which the leg portion 23 is in contact with the ground and becomes a Low level when the leg portion 23 is not in contact with the ground.

Here, there is illustrated an example in which the leg tip comes in contact with the ground earlier than the plan and leaves the ground earlier than the plan. For example, there is illustrated an example in which the leg tip is planned to come in contact with the ground at a time t2, but the leg tip actually comes in contact with the ground at a time t1 earlier than the time t2.

This example is considered to be caused by a case in which, for example, the automated moving body 11 leans forward due to the weights of the head portion 21 and the body portion 22 in a case in which the automated moving body 11 moves forward, hence the trajectory of the leg portion 23 becomes lower than the plan, and the leg portion 23 comes in contact with the ground earlier than the plan.

For example, the floor reaction force estimator 125 detects, as the ground contact timing of the leg portion 23, a timing at which the output value of the leg tip sensor 59 changes from the Low level to the High level. Moreover, the movement of the automated moving body 11 is usually a cyclic motion, and hence the floor reaction force estimator 125 calculates, as a movement cycle T, an average value of the cycles of the ground contact timing of the leg portion 23. Moreover, the floor reaction force estimator 125 estimates that the leg portion 23 comes in contact with the ground the movement cycle T after the previous ground contact timing of this leg portion 23.

For example, in the case in which the leg portion 23 comes in contact with the ground at the time t1, a timing at which the leg portion 23 comes in contact with the ground next time is estimated as Pc after the movement cycle T from the time t1.

The floor reaction force estimator 125 estimates the ground contact timing of each leg portion 23 through a similar method.

Note that the movement cycle T of the ground contact timing of each leg portion 23 is unknown immediately after the automated moving body 11 starts the movement. To handle this situation, the floor reaction force estimator 125, for example, uses the movement cycle T calculated at a previous movement time or uses a default value set in advance as the movement cycle T.

The floor reaction force estimator 125 generates the ground contact timing estimation information indicating the estimated ground contact timing of each leg portion 23 and supplies the ground contact timing estimation information to the leg tip position controller 132.

In Step S5, the automated moving body 11 adjusts the position of the leg tip.

Specifically, the posture stabilizer 131 calculates the position of the center of gravity which stabilizes the posture of the automated moving body 11, and the like on the basis of the estimated posture of the automated moving body 11. The posture stabilizer 131 generates the posture stabilization information indicating the calculated position of the center of gravity, and the like. The posture stabilizer 131 supplies the leg tip trajectory plan information and the posture stabilization information to the leg tip position controller 132.

The leg tip position controller 132 corrects the target position of the leg tip of each leg portion 23 on the basis of the position of the center of gravity, and the like for stabilizing the posture of the automated moving body 11 and the estimated value of the floor reaction force applied to each leg portion 23.

For example, the leg tip position controller 132 calculates a correction amount for the height of the target position of the leg tip of each leg portion 23 on the basis of the floor reaction force applied to each leg portion 23.

Note that the correction amount of the height of the target position of the leg tip of the leg portion 23fl is hereinafter denoted as Zoffset(Ffl). Note that the correction amount of the height of the target position of the leg tip of the leg portion 23fr is hereinafter denoted as Zoffset(Ffr). Note that the correction amount of the height of the target position of the leg tip of the leg portion 23hl is hereinafter denoted as Zoffset(Fhl). Note that the correction amount of the height of the target position of the leg tip of the leg portion 23hr is hereinafter denoted as Zoffset(Fhr).

Moreover, the leg tip position controller 132 corrects the target position of the leg tip of each leg portion 23 on the basis of the correction amount of the height of the target position of the leg tip of each leg portion 23.

For example, a target position P2fl of the leg tip of the leg portion 23fl after the correction, a target position P2fr of the leg tip of the leg portion 23fr after the correction, a target position P2hl of the leg tip of the leg portion 23hl after the correction, and a target position P2hr of the leg tip of the leg portion 23hr after the correction are given by the following Expressions (5) to (8).

$$P 2 fl = ( Xfl , Yfl , Zfl + Zoffset ( Ffl ) ) \qquad ( 5 )$$

$$P 2 fr = ( Xfr , Yfr , Zfr + Zoffset ( Ffr ) ) \qquad ( 6 )$$

$$P 2 hl = ( Xhl , Yhl , Zhl + Zoffset ( Fhl ) ) \qquad ( 7 )$$

$$P 2 hr = ( Xhr , Yhr , Zhr + Zoffset ( Fhr ) ) \qquad ( 8 )$$

The leg tip position controller 132 generates the leg tip trajectory corrected information indicating the target position of the leg tip of each leg portion 23 after the correction and supplies the leg tip trajectory corrected information to the inverse kinematic analyzer 133. Moreover, the leg tip position controller 132 corrects the estimated ground contact timing of each leg portion 23 on the basis of, for example, the target position of the leg tip of each leg portion 23 after the correction.

In Step S6, the inverse kinematic analyzer 133 calculates the joint angles of each leg portion 23 on the basis of the leg tip trajectory corrected information. That is, the inverse kinematic analyzer 133 executes inverse kinematic analysis, to convert the target position of the leg tip of each leg portion 23 after the correction to the target values of the joint angles of each leg portion 23. The inverse kinematic analyzer 133 generates the joint angle planned information indicating the target values of the joint angles of each leg portion 23 and supplies the joint angle plan information to the servo controller 104.

In Step S7, the automated moving body 11 calculates the servo gains.

For example, a leg tip phase of each leg portion 23 is denoted as Pt, the estimated ground contact timing thereof is denoted as Pc, and a range width of the ground contact phase thereof is denoted as R. Moreover, a period given by Pc−R≤Pt≤Pc+R is referred to as a ground contact phase in the leg tip phase of each leg portion 23. The ground contact phase is a period obtained by providing a margin before and after the estimated ground contact timing Pc and is a period from a timing before the estimated ground contact timing Pc by the range width R to a timing after the estimated ground contact timing Pc by the range width R. Each leg portion 23 is predicted to highly probably come in contact with the ground in the ground contact phase. Meanwhile, a period other than the ground contact phase of the leg tip phase is set as a normal phase. That is, the normal phase is a period other than a vicinity of the estimated ground contact timing in the leg tip phase of each leg portion 23.

Moreover, the servo gain is calculated through use of, for example, a gain function G(Pt, Pc, R) based on the leg tip phase Pt, the estimated ground contact timing Pc, and the range width R.

FIG. 5 described before indicates an example in which simple bang-bang control is applied to the servo gain. In this case, the gain function G(Pt, Pc, R) is given by the following Expression (9).

$$\begin{matrix}[ Math . 1 ] & \\ G ( Pt , Pc , R ) = \{ \begin{matrix}Low : Ground Contact Phase \\ High : Normal Phase\end{matrix} & ( 9 )\end{matrix}$$

That is, the servo gain is set to the Low level in the ground contact phase and is set to the High level in the normal phase. For example, the High level is set for a standard value of the servo gain, and the Low level is set for a value lower than the standard value of the servo gain.

The leg tip position controller 132 determines whether or not the leg tip phase of each leg portion 23 is in the ground contact phase on the basis of the estimated ground contact timing of each leg portion 23. The leg tip position controller 132 generates the ground contact determination information indicating the determination result of whether or not the leg tip phase of each leg portion 23 is in the ground contact phase and supplies the ground contact determination information to the gain controller 134.

The gain controller 134 sets the servo gains of the actuators 71 for driving the joints of each leg portion 23 on the basis of the ground contact determination information. Specifically, the gain controller 134 sets, to the Low level, the servo gain of the actuator 71 for driving each joint of the leg portion 23 determined to be in the ground contact phase. Meanwhile, the gain controller 134 sets, to the High level, the servo gain of each actuator 71 for driving the joint of each leg portion 23 determined to be in the normal phase. The gain controller 134 generates the gain information indicating the servo gain of each actuator 71 and supplies the gain information to the servo controller 104.

In Step S8, the automated moving body 11 drives each leg portion 23. Specifically, the servo controller 104 sets the servo gain of each actuator 71 on the basis of the gain information. Moreover, the servo controller 104 drives, on the basis of the joint angle plan information, each actuator 71 so that the joint angles of each leg portion 23 reach the planned angles.

As a result, the servo gain of the actuator 71 for driving each joint of the leg portion 23 in the ground contact phase is reduced (set to the Low level), and hence followability of this actuator 71 to disturbance is reduced. As a result, each joint of the leg portion 23 in the ground contact phase is likely moved by a force applied from the outside. That is, each joint of the leg portion 23 in the ground contact phase softens (each joint is loosened). In other words, the forces applied to the leg portion 23 in the ground contact phase are released.

Meanwhile, the servo gain of the actuator 71 for driving each joint of the leg portion 23 in the normal phase is set to the normal value (High level), and hence the followability of this actuator 71 to disturbance is increased. As a result, each joint of the leg portion 23 in the normal phase is unlikely moved by the force applied from the outside. That is, each joint of the leg portion 23 in the normal phase hardens (each joint is tightened). In other words, the forces of the leg portion 23 in the normal phase are applied.

That is, the forces of each leg portion 23 are released in the ground contact phase, and the forces are applied in the normal phase. As a result, the forces of the leg portion 23 in the air (hereinafter referred to as a free leg portion) out of the leg portions 23 are released immediately before the ground contact (more precisely, before the estimated ground contact timing by the range width R). Moreover, the forces of the free leg portion are applied immediately after the ground contact (more precisely, after the estimated ground contact timing by the range width R).

As a result, the reaction force transmitted from the ground to the free leg portion is dumped, and hence the free leg portion softly comes in contact with the ground. As a result, the footstep sound generated when the free leg portion comes in contact with the ground is suppressed. Moreover, the free leg portion is supported by the actuators 71 after the free leg portion comes in contact with the ground, and hence loss of the posture of the free leg portion is suppressed.

Moreover, as a result of the correction of the target position of the leg tip of each leg portion 23, the leg tip of each leg portion 23 moves along a trajectory close to the planned trajectory. Moreover, loss of the balance of the posture of the automated moving body 11 during the movement is suppressed (the inclination of the body of the automated moving body 11 is corrected), and hence the posture of the automated moving body 11 is stabilized.

For example, in a case in which the automated moving body 11 leans forward due to the weights of the head portion 21 and the body portion 22, a curve of the fore leg portion 23 in contact with the ground is reduced, and a curve of the hind leg portion 23 in contact with the ground is increased. As a result, thus, the fore leg portion 23 in contact with the ground extends, the hind leg portion 23 in contact with the ground contracts, so that the inclination of the body is corrected to approach the horizontal direction. As a result, not only the posture of the automated moving body 11 is stabilized, but such a situation that the leg tip of the free leg portion collides with the ground earlier than the plan and the footstep sound is generated is suppressed.

Further, as a result of the correction of causing the inclination of the body to approach the horizontal direction, the fore leg portions 23 rise high. Moreover, as described above, the free leg portion softly comes in contact with the ground. As a result, for example, there increases a travel capability on a step such as a carpet or a joint mat and a rugged terrain.

In Step S9, the movement instructor 101 determines whether or not the target position has been reached. In a case in which it is determined that the target position has not been reached, the processing returns to Step S1.

After that, the processing from Step S1 to Step S8 is repeatedly executed until it is determined that the target position has been reached in Step S9.

Meanwhile, in a case in which it is determined that the target position has been reached in Step S8, the movement control processing is ended.

As described above, the posture of the automated moving body 11 at the movement time can be stabilized, and this can suppress the footstep sound.

Moreover, the algorithm for achieving this effect is simple, hence it is not required to use an expensive sensor and a processor having a high calculation capability, and the cost of the automated moving body 11 can be suppressed.

Further, it is possible to tune a movement cycle T and the control parameters such as the range width R to stabilize the posture of the automated moving body 11, and this can achieve an effect of suppressing the walk sound, regardless of an individual difference and an aged deterioration of the automated moving body 11 and a difference in the peripheral environment and the like.

Note that, as described above, these control parameters are adjusted not only by directly using the detection result of the ground contact timing, but may indirectly be adjusted such that, for example, the footstep sound collected by the microphones 52 decreases or the vibration of the IMUs 60 decreases.

Moreover, as the initial value of this control parameter, for example, an average value of the control parameters adjusted in a plurality of automated moving bodies 11 in advance is used.

### 2. MODIFICATION EXAMPLES

A description is now given of modification examples of the embodiment of the present technology described above.

For example, the correction amount Zoffset of the height of the target position of the leg tip of each leg portion 23 may be calculated through use of the following Expression (10).

$$Zoffset ( F , P ) = F \times G \times O max ( P ) \qquad ( 10 )$$

F denotes the leg tip load, P denotes the leg tip phase, G denotes an adjustment gain for each leg portion 23, and Omax(P) denotes the maximum value of the correction amount.

Note that the leg tip load F may be added through interior division on the basis of, for example, the ZMP and the ground contact point of each leg portion 23. Moreover, the maximum value Omax(P) of the correction amount, for example, may be a fixed value or may dynamically be changed.

Further, for example, a sinking amount of the body portion 22 according to the leg tip load may be measured and an approximate expression of Zoffset (F) may be created and may be applied.

Moreover, for example, the foot sole switch may be used for the leg tip sensor 59 as described before.

Further, for example, at the time of the ground contact of the free leg portion, it is predicted that a current value of the actuator 73 of the free leg portion in contact with the ground increases and an error of the servo encoder 102 increases. Thus, for example, a physical sensor may not be used, and the current value of the actuator 73 or the error of the servo encoder 102 may be used to detect the ground contact timing of the automated moving body 11.

In the description given above, the case in which the joints of the free leg portion are tightened after the predetermined time at the estimated ground contact timing of this free leg portion is exemplified, but the joints of the free leg portion may be tightened, for example, after the detection of the actual ground contact of the free leg portion on the basis of the detection result of the leg tip sensor 59 of the free leg portion.

In the description given above, there is described the example in which all of the joints of the free leg portion out of the leg portions 23 are loosened, but the effect of suppressing the footstep sound can be obtained by, for example, loosening at least one or more joints of the free leg portion.

The present technology can be applied to an automated moving body having two or more legs. That is, in the automated moving body having two or more legs, the joints of the free leg are loosened before the ground contact and are tightened after the ground contact, and this can achieve the suppression of the walk sound.

### 3. OTHERS

### Configuration Example of Computer

The series of processing described above may be carried out by hardware or may be carried out by software. In a case in which the series of processing is carried out by the software, a program of this software is installed on a computer. Here, the computer includes a computer built into dedicated hardware, and, for example, a general-purpose personal computer which can carry out various functions by installing various programs.

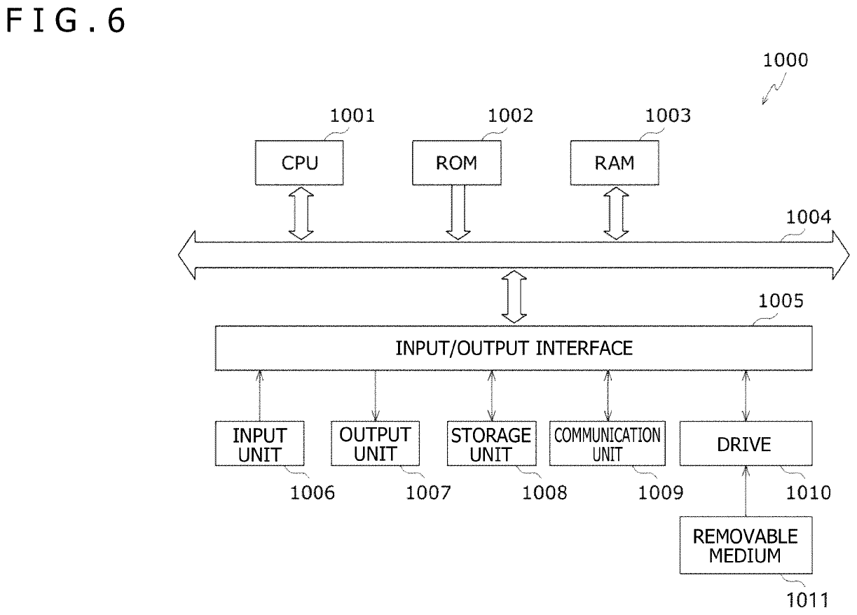

FIG. 6 is a block diagram for illustrating a configuration example of hardware of the computer which carries out the series of processing described above through a program.

In a computer 1000, a CPU (Central Processing Unit) 1001, a ROM (Read Only Memory) 1002, and a RAM (Random Access Memory) 1003 are connected to one another via a bus 1004.

To the bus 1004, an input/output interface 1005 is further connected. To the input/output interface 1005, an input unit 1006, an output unit 1007, a storage unit 1008, a communication unit 1009, and a drive 1010 are connected.

The input unit 1006 includes an input switch, a button, a microphone, an imaging element, and the like. The output unit 1007 includes a display, a speaker, and the like. The storage unit 1008 includes a hard disk, a nonvolatile memory, and the like. The communication unit 1009 includes a network interface and the like. The drive 1010 drives a removable medium 1011 such as a magnetic disk, an optical disc, a magneto-optical disk, or a semiconductor memory.

In the computer 1000 configured as described above, the CPU 1001, for example, loads a program recorded in the storage unit 1008 on the RAM 1003 via the input/output interface 1005 and the bus 1004 and executes the program, and this carries out the series of processing described above.

The program executed by the computer 1000 (CPU 1001) can be provided by, for example, recording the program in the removable medium 1011 serving as a package medium and the like. Moreover, the program can be provided via a wired or wireless transmission medium such as a local area network, the Internet, and digital satellite broadcast.

In the computer 1000, the program can be installed in the storage unit 1008 via the input/output interface 1005 by mounting the removable medium 1011 to the drive 1010. Moreover, the program can be received by the communication unit 1009 via the wired or wireless transmission medium and can be installed in the storage unit 1008. In addition, the program can be installed, in advance, in the ROM 1002 or the storage unit 1008.

Note that the program executed by the computer may be a program for carrying out processing as a time series along the sequence described in the present specification or a program for carrying out processing in parallel or at a required timing such as a timing at which a call is made.

In the present specification, the system means a set of a plurality of components (apparatuses, modules (parts), and the like), and whether or not all of the components exist in the same housing does not matter. Thus, any one of a plurality of apparatuses stored in individual housings and connected via a network and one apparatus including a plurality of modules stored in one housing is the system.

Further, the embodiment of the present disclosure is not limited to the embodiment described above, and various changes can be made within a scope without departing from the gist of the present technology.

For example, the present technology can have a configuration of the cloud computing in which one function is distributed to and processed in cooperation by a plurality of apparatuses via a network.

Moreover, each step described in the flowchart described above can be carried out by one apparatus as well as can be allocated to and carried out by a plurality of apparatuses.

Additionally, in a case in which a plurality of pieces of processing is included in one step, the plurality of pieces of processing included in this one step can be carried out by one apparatus as well as can be allocated to and carried out by a plurality of apparatuses.

### Example of Combination of Configurations

The present technology can also take the following configurations.

(1)

An automated moving body including:
two or more legs; and
a motion control unit that controls each of the legs such that a force of a free leg out of the legs is released before ground contact of the free leg and the force of the free leg is applied after the ground contact of the free leg.
   (2)

The automated moving body according to (1) above, in which
the motion control unit softens at least one of joints of the free leg before the ground contact of the free leg and hardens the softened joint after the ground contact of the free leg.
   (3)

The automated moving body according to (2) above, in which
the motion control unit reduces the servo gain of an actuator that drives the joint to be softened and increases the servo gain of an actuator that drives the joint to be hardened.
   (4)

The automated moving body according to (2) or (3) above, in which
the motion control unit softens all of the joints of the free leg before the ground contact of the free leg and hardens all of the softened joints after the ground contact of the free leg.
   (5)

The automated moving body according to any one of (1) to (4) above, in which
the motion control unit controls a rotation angle of the joint of the leg in contact with the ground to stabilize a posture during a movement.
   (6)

The automated moving body according to (5) above, in which
the motion control unit controls the rotation angle of the joint of the leg in contact with the ground to correct inclination of the body during the movement.
   (7)

The automated moving body according to (5) or (6) above, further including:
a posture estimation unit that estimates the posture on the basis of at least one of an acceleration, an angular velocity, and a rotation angle of the joint of each leg of the automated moving body, in which
the motion control unit stabilizes the posture on the basis of an estimation result of the posture.
   (8)

The automated moving body according to any one of (1) to (7) above, further including:
a floor reaction force estimation unit that estimates a ground contact timing of the free leg on the basis of a detection result of a ground contact timing of each leg during the movement, in which
the motion control unit releases the force of the free leg before the estimated ground contact timing of the free leg.
   (9)

The automated moving body according to (8) above, in which
the motion control unit applies the force of the free leg after the estimated ground contact timing of the free leg by a predetermined time.
   (10)

A movement control method including:
by an automated moving body including two or more legs,
controlling a motion of each of the legs such that a force of a free leg out of the legs is released before ground contact of the free leg and the force of the free leg is applied after the ground contact of the free leg.

Note that the effects described in the present specification are merely examples and not limited, and any other effect may be provided.

### REFERENCE SIGNS LIST

11: Automated moving body
21: Head portion
22: Body portion
23fr to 23hr: Leg portion
24: Tail portion
59fl to 59hr: Leg tip sensor
71A to 71Ghr: Actuator
101: Movement instructor
102: Servo encoder
103: Movement controller
104: Servo controller
121: Gait generator
122: Leg tip trajectory generator
123: Forward kinematic analyzer
124: Posture estimator
125: Floor reaction force estimator
126: Motion controller
131: Posture stabilizer
132: Leg tip position controller
133: Inverse kinematic analyzer
134: Gain controller

1. An automated moving body comprising:
two or more legs; and
a motion control unit that controls each of the legs such that a force of a free leg out of the legs is released before ground contact of the free leg and the force of the free leg is applied after the ground contact of the free leg.

2. The automated moving body according to claim 1, wherein
the motion control unit softens at least one of joints of the free leg before the ground contact of the free leg and hardens the softened joint after the ground contact of the free leg.

3. The automated moving body according to claim 2, wherein
the motion control unit reduces the servo gain of an actuator that drives the joint to be softened and increases the servo gain of an actuator that drives the joint to be hardened.

4. The automated moving body according to claim 2, wherein
the motion control unit softens all of the joints of the free leg before the ground contact of the free leg and hardens all of the softened joints after the ground contact of the free leg.

5. The automated moving body according to claim 1, wherein
the motion control unit controls a rotation angle of the joint of the leg in contact with the ground to stabilize a posture during a movement.

6. The automated moving body according to claim 5, wherein
the motion control unit controls the rotation angle of the joint of the leg in contact with the ground to correct inclination of the body during the movement.

7. The automated moving body according to claim 5, further comprising:
a posture estimation unit that estimates the posture on a basis of at least one of an acceleration, an angular velocity, and a rotation angle of the joint of each leg of the automated moving body, wherein
the motion control unit stabilizes the posture on a basis of an estimation result of the posture.

8. The automated moving body according to claim 1, further comprising:
a floor reaction force estimation unit that estimates a ground contact timing of the free leg on a basis of a detection result of a ground contact timing of each leg during the movement, wherein
the motion control unit releases the force of the free leg before the estimated ground contact timing of the free leg.

9. The automated moving body according to claim 8, wherein
the motion control unit applies the force of the free leg after the estimated ground contact timing of the free leg by a predetermined time.

10. A movement control method comprising:
by an automated moving body including two or more legs,
controlling a motion of each of the legs such that a force of a free leg out of the legs is released before ground contact of the free leg and the force of the free leg is applied after the ground contact of the free leg.
